(19) United States
(12) Patent Application Publication
(10) Pub. No.: US 2025/0050800 A1
(43) Pub. Date: Feb. 13, 2025

(54) Truck Bed Divider

(71) Applicant: Loading Zone I, LLC, New Berlin, WI (US)

(72) Inventor: Scott Biller, New Berlin, WI (US)

(21) Appl. No.: 18/800,765

(22) Filed: Aug. 12, 2024

Related U.S. Application Data
(60) Provisional application No. 63/532,176, filed on Aug. 11, 2023.

(51) Int. Cl. B60P 7/14

(52) U.S. Cl. CPC B60P 7/14

(57) ABSTRACT

A truck bed divider for use with a truck bed including a bottom floor and a pair of opposed side walls extending upwardly from the bottom floor, the divider including a panel having a top rail, a bottom rail, and a pair of opposed side rails joining the top rail and the bottom rail, at least one first adjustable securing member attached to the panel and engageable with the side wall of the truck bed, and an adjustable vertical extension secured to the bottom rail and engageable with the bottom floor of the truck bed.

### CROSS-REFERENCE TO RELATED APPLICATIONS

The present application claims priority from U.S. Provisional Patent Application Ser. No. 63/532,176, filed on Aug. 11, 2023, the entirety of which is expressly incorporated herein by reference for all purposes.

### FIELD OF THE INVENTION

The present invention relates to truck bed dividers, and more specifically to an adjustable telescoping element with securing clamp mechanism used to retain the divider in a specified position within the truck bed.

### BACKGROUND OF THE INVENTION

Pickup trucks are often used to carry items from one place to another. The enclosed bed of the truck allows the items to be retained within the bed while the truck is moving. However, on many occasions, the items that are to be carried in the bed of the truck are not large enough to be securely retained within the truck bed by the walls of the bed without an additional securing structure.

As a result, a number of truck bed dividers have been developed-that segregate the truck bed into sections that conform closely to the size of the items placed in the truck bed to more securely retain the items in the bed. The dividers generally include a rectangular panel or array of panels that extends across the truck bed between the side walls. The divider is secured to the side walls of the truck bed to retain the divider in a stationary position while the truck is moving. The dividers also engage the bottom floor of the truck bed in order to retain the divider in a position perpendicular to the bottom floor while the truck is moving. This prevents the divider from swinging outwardly when contacted by one or more of the items retained by the divider, and allowing those items to slide beneath the divider and possibly out of the truck bed.

Many truck bed dividers have been developed that utilize various configurations for segregating the interior of a truck bed. However, with most of these truck bed dividers, the dividers are designed for the specific dimensions of a truck bed for a particular truck or line of trucks. Therefore, if an individual wishes to purchase a truck bed divider for a truck, that individual must know the exact dimensions of the truck bed, or type of truck with which the divider is to be utilized in order to insure that the truck bed divider fits the truck bed. This is particularly true with respect to the width of the divider and the securing mechanism used to secure the divider between the side walls of the truck bed. If the width and/or height of the divider is too short and the securing mechanism cannot reach the side walls and/or bottom floor, or the divider and securing mechanism cannot fit between the side walls because it is too wide, that divider cannot be used with the truck bed.

Therefore, it is desirable to develop a truck bed divider that includes adjustable horizontal and vertical securing mechanisms that are capable of securing the truck bed divider within truck beds having varying lengths between the side walls of the bed.

### SUMMARY OF THE DISCLOSURE

According to one exemplary embodiment of the present disclosure, a truck bed divider for use with a truck bed including a bottom floor and a pair of opposed side walls extending upwardly from the bottom floor, the divider including a panel having a top rail, a bottom rail, and a pair of opposed side rails joining the top rail and the bottom rail, at least one first adjustable securing member attached to the panel and engageable with the side wall of the truck bed, and an adjustable vertical extension secured to the bottom rail and engageable with the bottom floor of the truck bed.

Other objectives, features, benefits and advantages of the present invention will be apparent from this summary and its descriptions of certain embodiments of such formulations and compositions, and will be readily apparent to those skilled in the art having knowledge of the synthetic techniques described therewith. Such objectives, features, benefits and advantages will be apparent from the above as taken into conjunction with the accompanying examples, data, and all reasonable inferences to be drawn therefrom.

### BRIEF DESCRIPTION OF THE DRAWINGS

The following drawings illustrate the best mode currently contemplated of practicing the present invention.

FIG. 1 is an isometric view of a truck bed divider including one embodiment of the adjustable securing latch mechanism of the present invention;

FIG. 2 is a top plan view of the truck bed divider of FIG. 1;

FIG. 3 is side plan view of the divider of FIG. 1;

FIG. 4 is an exploded front elevational view of the divider of FIG. 1;

FIG. 5 is a partially broken away, isometric view of a securing clamp of the divider of FIG. 1;

FIG. 6 is a partially broken away, isometric view of an engaging clamp of the divider of FIG. 1;

FIG. 7 is partially broken away, bottom isometric view of the bottom rail of the divider of FIG. 1;

FIG. 8 is an isometric view of a securing foot of the divider of FIG. 1.

FIG. 9 is an isometric view of a truck bed divider including another embodiment of the adjustable securing latch mechanism of the present invention;

FIG. 10 is an isometric view of foot of the truck bed divider of FIG. 9;

FIG. 11 is a partially broken away, isometric view of the foot attached to the divider of FIG. 9;

FIG. 12 is a partially broken away, bottom isometric view of the foot secured to the divider of FIG. 9;

FIG. 13 is a partially broken away, isometric view of the foot attached to the divider of FIG. 9;

FIG. 14 is a partially broken away, isometric view of a securing clamp of the divider of FIG. 1;

FIG. 15 is an isometric view of a truck bed divider including still another embodiment of the adjustable securing latch mechanism of the present invention;

FIG. 16 is an exploded isometric view of the divider of FIG. 15;

FIG. 17 is a partially broken away, isometric view of the divider of FIG. 15;

FIG. 18 is a partially broken away, isometric view of the divider of FIG. 15 with a foot in a storage configuration;

FIG. 19 is an isometric view of the foot of FIG. 18;

FIG. 20 is a partially broken away, bottom isometric view of the divider of FIG. 18;

FIG. 21 is an isometric view of a high-friction boot attached to the foot of FIG. 19;

FIG. 22 is an isometric view of a first extension arm of the divider of FIG. 15;

FIG. 23 is a partially broken away, isometric view of the divider of FIG. 15 including a second extension arm engaged therewith;

FIG. 24 is an isometric view of a cam lock key engaged with the divider and second extension arm of FIG. 23; and

FIG. 25 is an isometric view of a high-friction boot attached to the first and second extension arms of the divider of FIG. 15.

### DETAILED DESCRIPTION OF THE DISCLOSURE

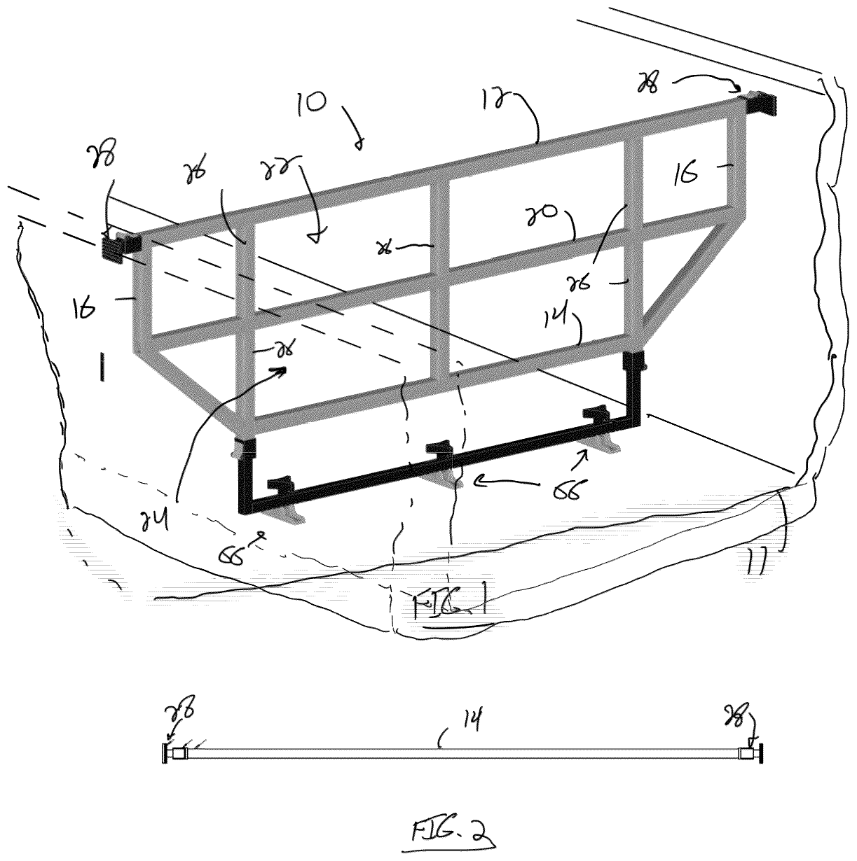

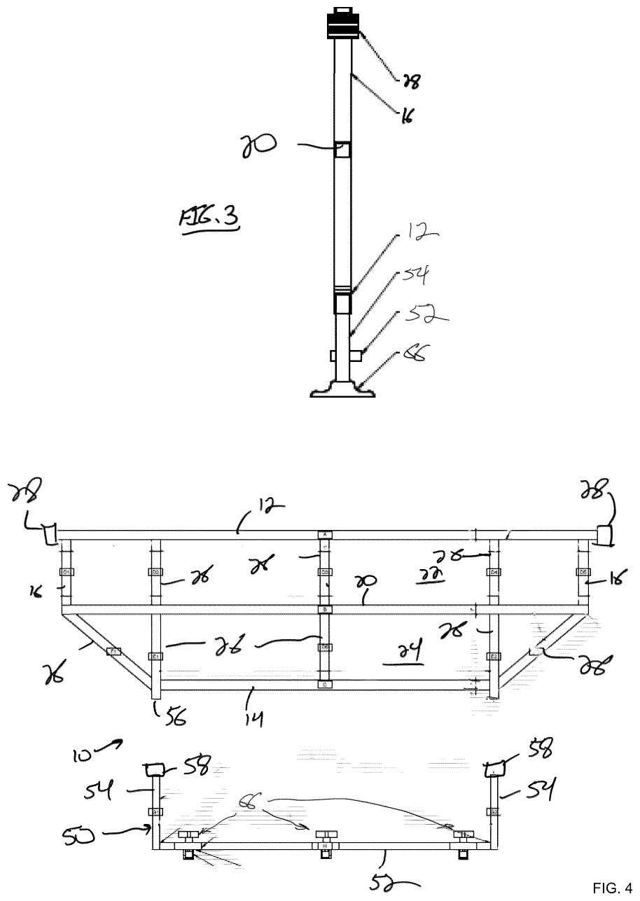

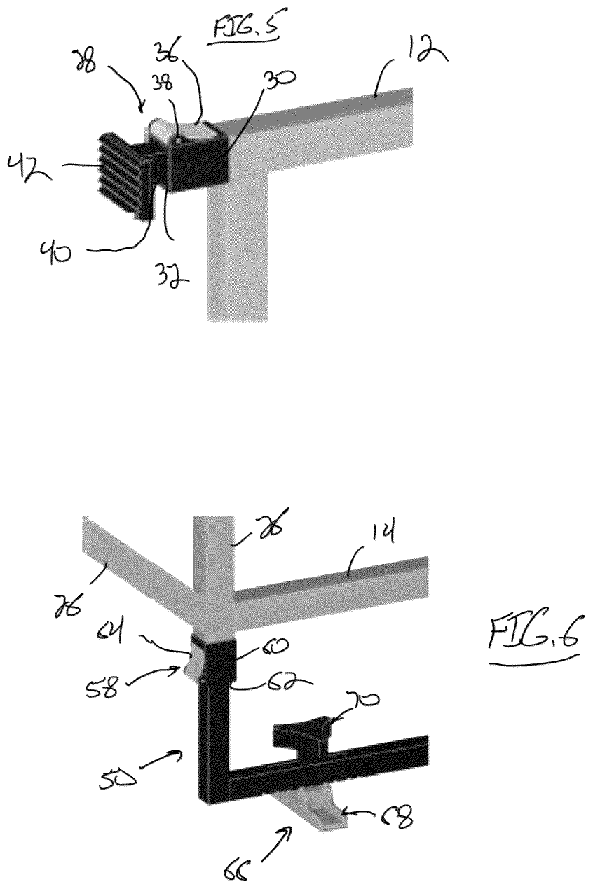

With reference now to the drawing figures in which like reference numerals designate like parts throughout the disclosure, a truck bed divider constructed according to the present invention is indicated generally at 10 in FIGS. 1-4, and similar to those disclosed in U.S. Pat. No. 6,626,624, entitled Latch Mechanism For Truck Bed Divider, and U.S. Pat. No. 6,543,975, entitled Height Adjustment System For Truck Bed Divider, the entirety of which are each expressly incorporated herein by reference for all purposes. The divider 10 is positioned within a truck bed 11 and includes a main frame 13 that is generally rectangular in shape, including a top rail 12, a bottom rail 14, and a pair of side rails 16 connecting the top and bottom rails. The top rail 12, bottom rail 14 and side rails 16 are each formed as a hollow tube comprised of a lightweight, rigid material capable of handling a significant amount of stress. Examples of these types of materials include thermosetting plastics and metals.

The divider 10 also includes a center rail 20 spaced between and extending parallel to the top rail 12 and bottom rail 14, and secured to the side rails 16. The center rail 20 is formed similarly to the top rail 12 and bottom rail 14 and separates the divider 10 into an upper portion 22 and a lower portion 24.

Both the upper portion 22 and lower portion 24 include a number of supports 26 disposed between the top rail 12 and center rail 20, and center rail 20 and bottom rail 14, respectively. The supports 26 provide additional strength and rigidity to the divider 10, and operate to prevent any items secured by the divider 10 from passing through the upper portion 22 or lower portion 24 of the divider 10. The supports 26 are each formed of a material similar to that of the top rail 12, bottom rail 14 and center rail 20, such that the supports 26 can be formed as integral components of the divider 10, or readily secured to the rails 12,14,20 in any suitable manner for the types of materials forming the rails 12,14 and 20, including welding and adhesives, among others. The supports 26 are also spaced from one another within the upper portion 22 and the lower portion 24, in the same or different configurations, in order to reduce the wind resistance of divider 10 as well as the overall weight of the divider.

Referring now to FIGS. 1-5, the divider 10 further includes a pair of clamps 28 disposed on each end of the top rail 12. The clamps 28 operate to engage and secure the top rail 12 between opposite sides of the truck bed 11. The clamps 28 can have a variety of forms, but in the illustrated exemplary embodiment of FIG. 5, the clamps 28 each include a sleeve 30 secured to each end of the top rail 12. The sleeve 30 defines a channel 32 therein that is aligned with a hollow interior 34 of the top rail 12. The sleeve 30 also includes a latch 36 that is moveably disposed on the sleeve 30, such as by a pivot pin 38 engaged with the sleeve 30 and extending through the latch 36, and that at least partially extends into the channel 32 in a locking position for the latch 36 relative to the sleeve 30.

The clamps 28 each engage an extension arm 40. The arm 40 is positioned within the channel 32 and at least a part of the interior 34 of the top rail 12, and is able to slide with respect to the channel 32 and the interior 34. Opposite the interior 34, the arm 40 includes a pad 42 attached to the arm 40 and formed of a compressible, high friction material, such as a rubber. The pad 42 also has at least one dimension, e.g., length, width, etc., greater than that of the arm 40 to provide a larger surface area for engagement of the pad 42 with the truck bed 11.

When the latch 36 is in the disengaged position, the arm 40 can slide freely within the channel 32 and interior 34 to enable the pad 42 to be placed against the truck bed 11. In the selected engaged position, the latch 36 can be moved into the locking position, such as into an over-center cam locking position, to engage the arm 40 within the channel 32 and secure the arm 40 in the selected position relative to the top rail 12 and the truck bed 11. In this position, the engagement of the latch 36 with the arm 40 and the pad 42 with the truck bed 11 effectively horizontally locks the divider 10 in the desired position between the opposed sides of the truck bed 11.

In order to vertically support the divider 10 within the truck bed 11, a bottom extension 50 is attached to the bottom rail 14 of the divider 10. The bottom extension 50 is formed similar to the divider 10 of a hollow tubular member having a lower rail 52 and a pair of upwardly extending end rails 54 disposed at opposed ends of the lower rail 52.

To attach the bottom extension 50 to the divider 10, the end rails 54 are inserted within a hollow interior 56 of the bottom rail 14 and/or an aligned support 26. The interiors 56 are each also aligned with an engaging clamp 58 formed similarly to clamp 28 and secured to the bottom rail 14 and/or support 26. Each clamp 58 includes a sleeve 60 defining a channel 62 therein aligned with the interior 56 and a latch 64 pivotally attached to the sleeve 60 and moveable between locked and unlocked positions relative to the sleeve 60.

To secure the extension 50 to the divider 10, the end rails 54, which have dimensions smaller than the interiors 56 and the channels 62, are inserted through the channels 62 and into the interiors 56. The latches 64 can then be moved into the locking positions to engage the end rails 54 within the sleeves 60 to attach the extension 50 to the divider 10.

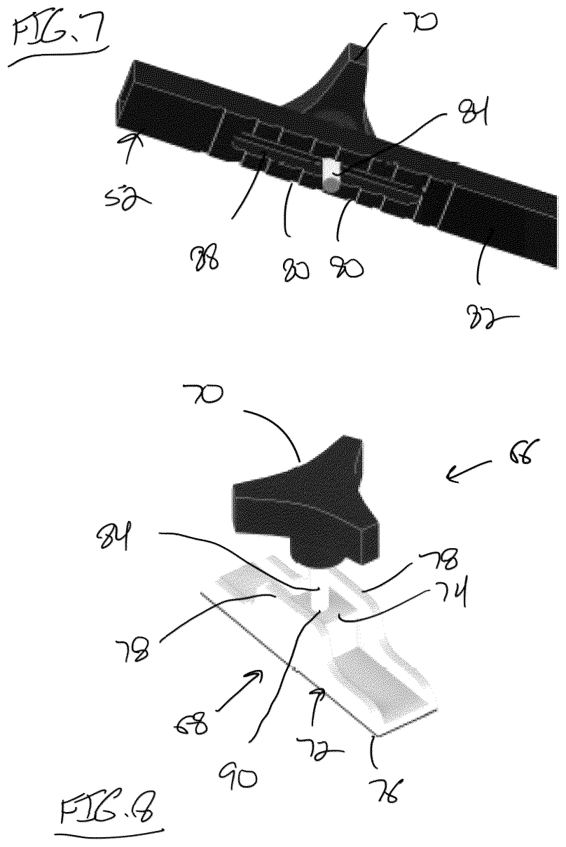

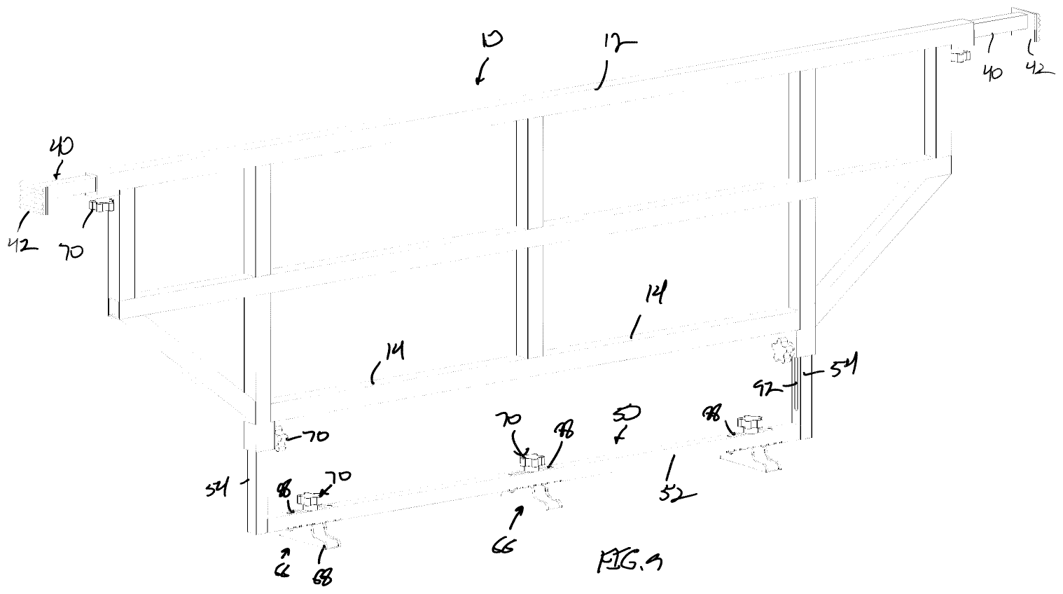

Referring now to FIGS. 1 and 6-8, to hold and support the extension 50 relative to the bottom of the truck bed 11, the extension 50 also includes a number of adjustable securing feet 66 positioned on the lower rail 52. The feet 66 each include an engagement member 68 and an adjustment knob 70 adjustably secured to the engagement member 68. The engagement member 68 is formed of a rigid material including a wide lower end 72 and a narrow upper end 74. The wide lower end 72 can include a high friction pad 76 thereon to assist in holding the lower end 72 in a stationary position against the truck bed 11. The upper end 74 includes a pair of spaced ridges 78 that can engage complementary shaped notches 80 formed in a lower surface 82 of the lower rail 52, as shown in FIG. 7, in order to prevent the upper end 74, and consequently the engagement member 68, from sliding relative to the lower rail 52.

The adjustment knob 70 includes a threaded rod 84 extending outwardly from a handle 86. The rod 84 can be inserted through a slot 88 in the lower rail 52 and into engagement within a threaded bore 90 disposed in the upper end 74 between the ridges 78. With the placement of the rod 84 in the slot 88, the position of the engagement member 68 can be adjusted relative to the lower rail 52 to ensure the proper placement of the lower end 72 of the engagement member 68 against the truck bed 11 to accommodate for uneven surfaces of the truck bed 11. This secures the alignment member 68 in position on the lower rail 52, such that when the engagement member 68 is pressed against the truck bed 11 during positioning of the divider 10, the extension 50, and thus the lower rail 14 of the divider 10, are securely engaged to the floor of the truck bed 11 by the engagement members 68.

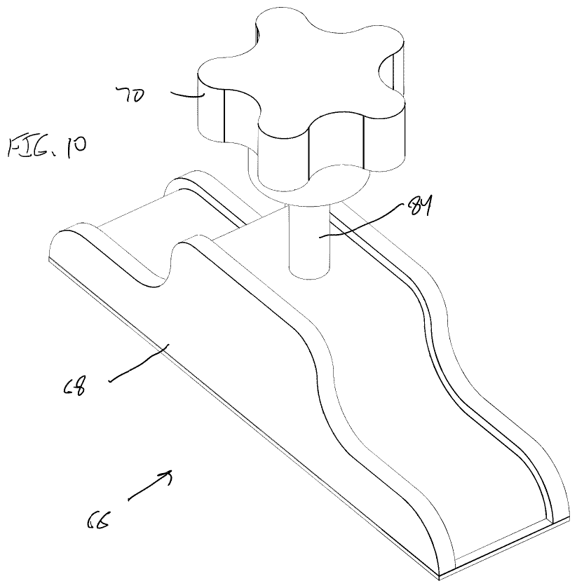

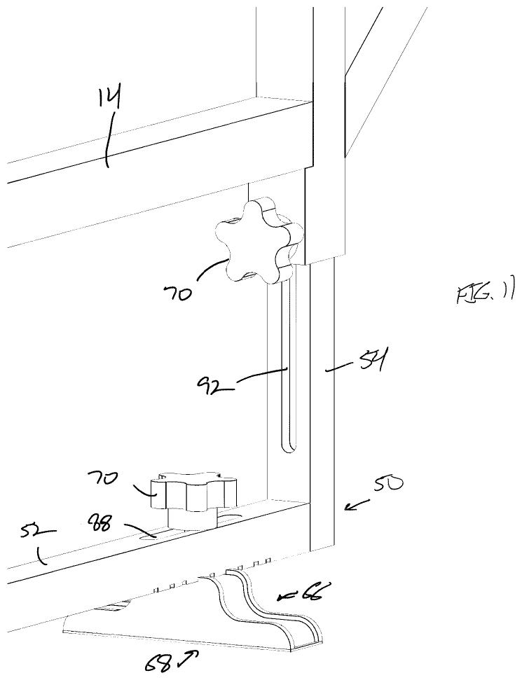

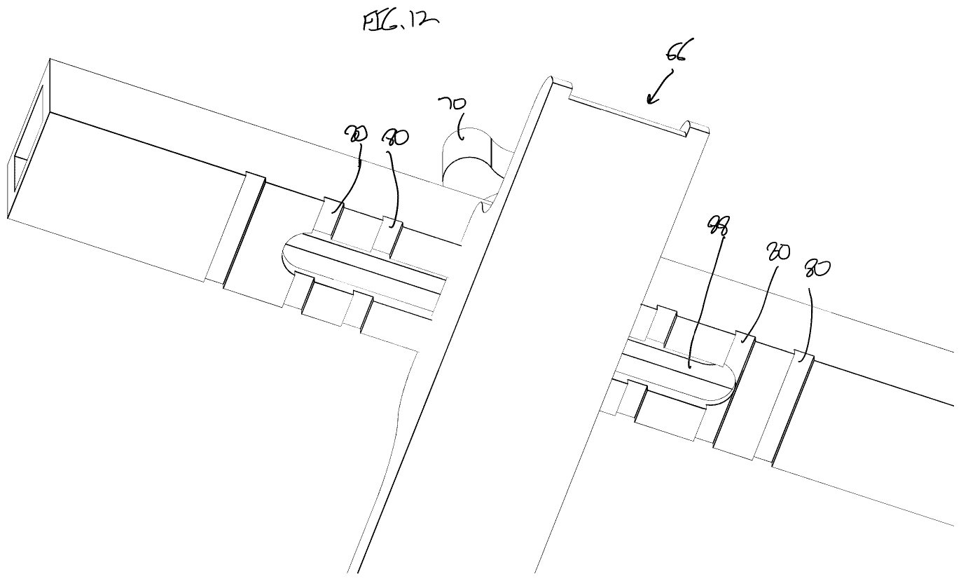

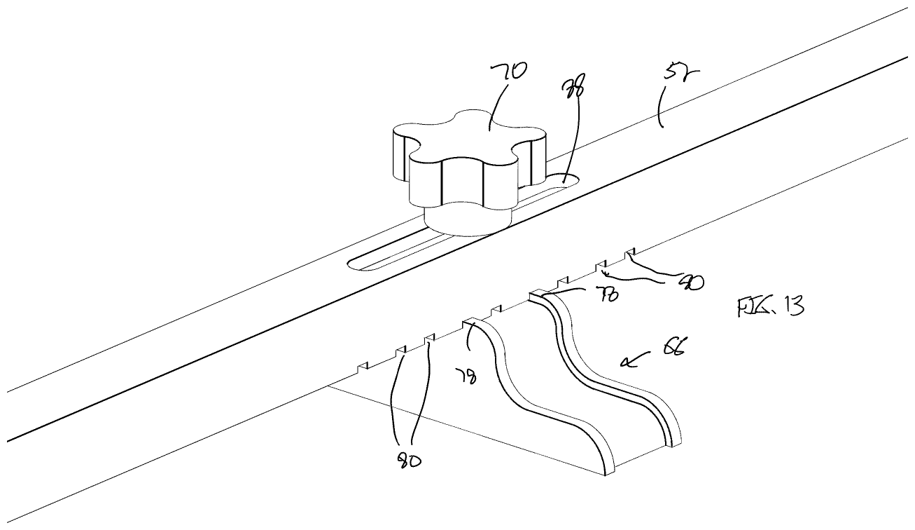

In another embodiment of the disclosure, as shown in the exemplary embodiments illustrated in FIGS. 9-14, the clamps 28 securing the extension 50 to the bottom rail 14 of the divider 10 and securing the extension arms 40 to the top rail 12 of the divider 10 can be replaced by threaded adjustment knobs 70. The knobs 70 are each inserted within threaded bores 72 in the divider 10 and extend into the interior 34 of the top rail 12 and the interior 56 of bottom rail 14. The rods 84 on each knob 70 extend into slots 92 formed in the arms 40 and the end rails 54 where they engage a compression member such as an anti-vibration washer 94 (FIGS. 11 and 14) disposed within the arm 40 and/or end rail 54 and aligned with the slot 92 for a secure friction fit or similar structure disposed within the arms 40 and end rails 54. Engagement of the rods 84 with the compression member 94 through the slot 92 can pull the rod knob 70 against the arm 40 or end rail 54, pulling the washer 94 within the arm 40 or end rail 54 into secure engagement with the top rail 12 or bottom rail 14, respectively, to hold the arms 40 and/or extension 50 in the desired position with regard to the divider 10 for proper placement within the truck bed 11.

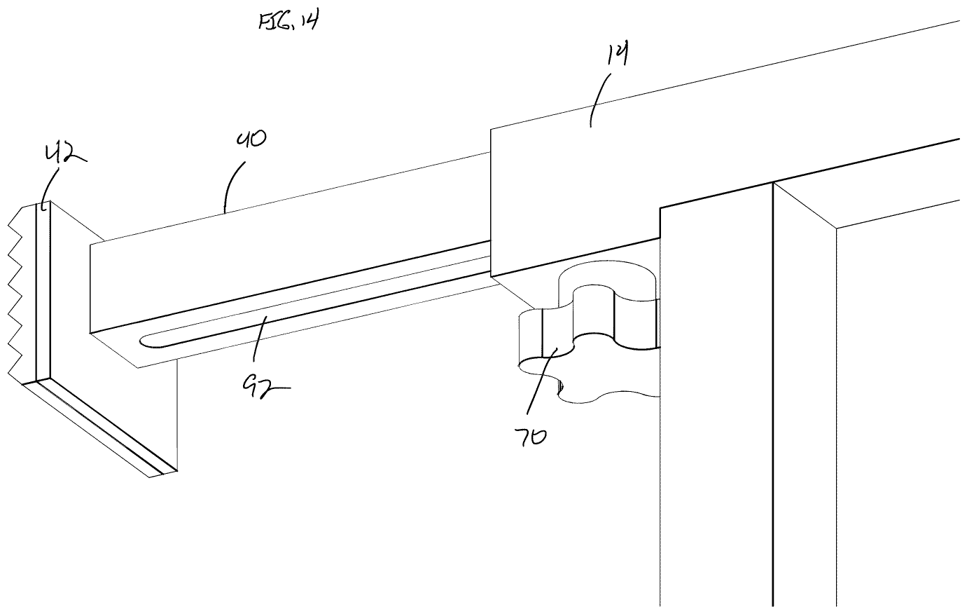

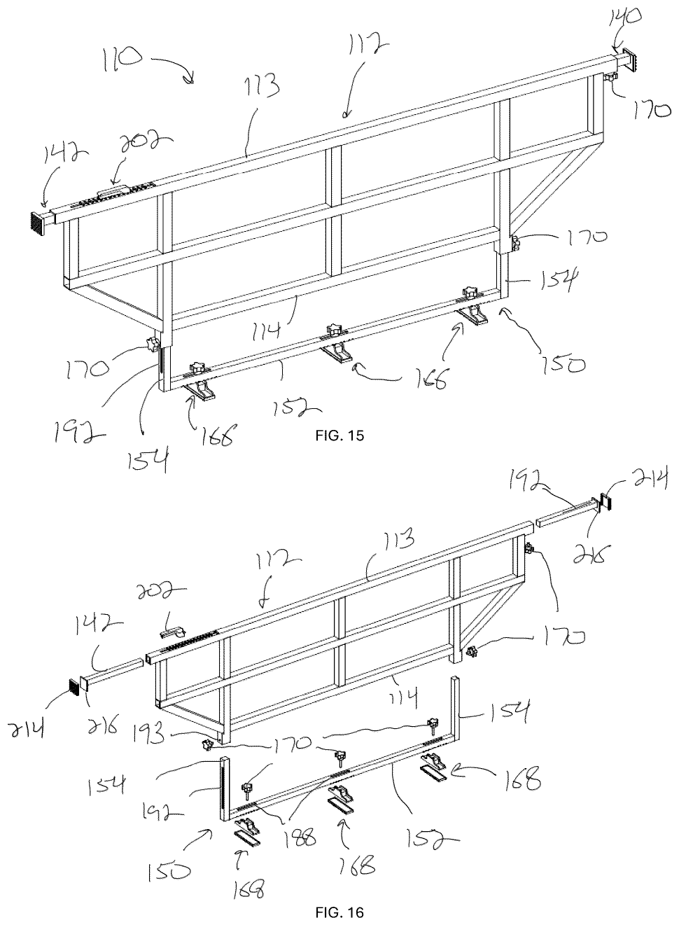

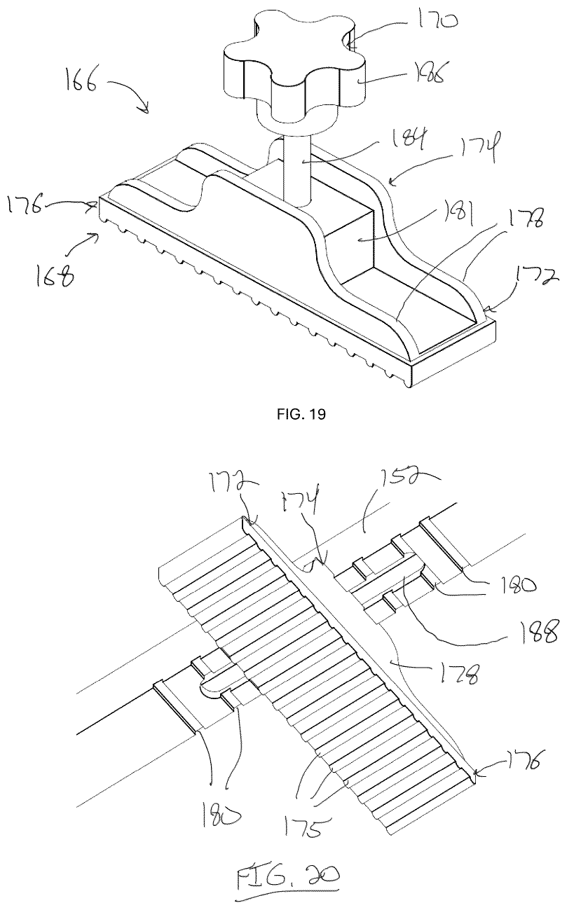

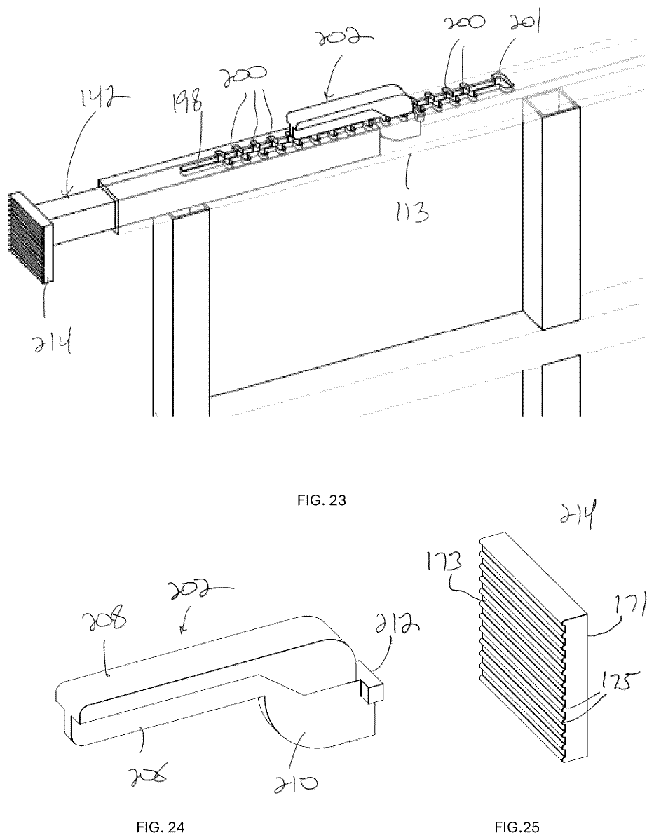

With reference now to FIGS. 15-25, a second embodiment of the divider 110 is illustrated. The divider 110 includes a main frame 112 formed with top, side, center and bottom rails similarly to the divider 10 of FIG. 1.

Looking now at the exemplary embodiments of FIGS. 15-17, the divider 110 includes an extension 150 formed similarly to the extension 50 of divider 10 with lower rail 152 and end rails 154. The end rails 154 are secured to the main frame 112 by threaded adjustment knobs 170. The knobs 170 include rods 84 extend that extend through the main frame 112 into slots 192 formed in the end rails 154 where threaded ends of the rods 184 opposite the knobs 170 engage a compression member such as an anti-vibration washer 194 disposed within the end rail 154 and aligned with the slot 192. The rotation of the rods 184 into the compression member 194 through the slot 192 can compress the knob 170 against the end rail 154, also pulling the washer 194 against the end rail 154 into secure engagement with the bottom rail 114 to hold the extension 150 in the desired position with regard to the main frame 112 for proper placement within the truck bed 11. Further, by rotating the know 170 to disengage the knob 170 from the frame 112 and the washer 194 from the end rail 154, but leaving the rod 184 engage with the washer 194, the end rail 154 can be adjusted relative to the main frame 112 without completely disengaging the extension 150 from the main frame 112.

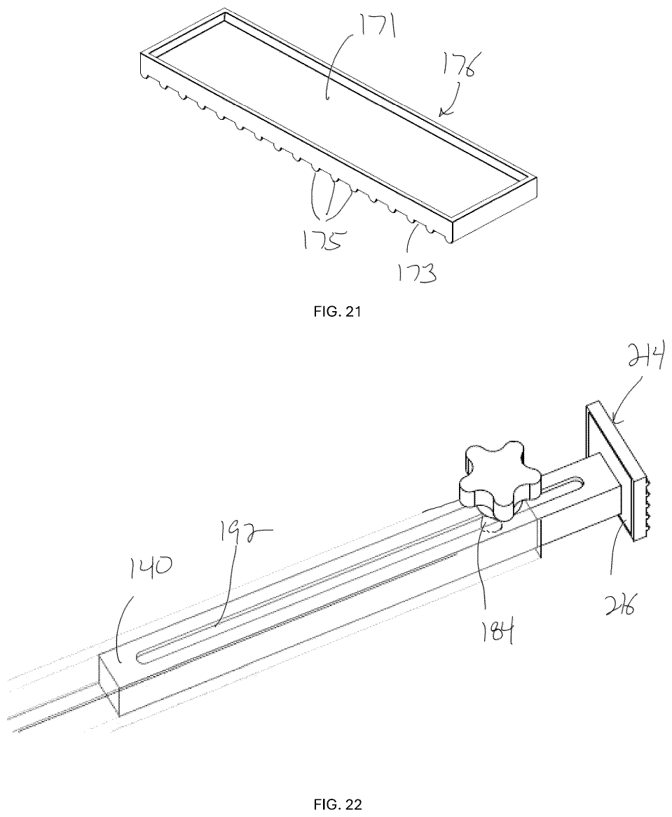

Referring now to the exemplary embodiments of FIGS. 15, 16 and 18-21, the divider 110 on the extension 150 also includes a number of adjustable securing feet 166 positioned on the lower rail 152. The feet 166 each include an engagement member 168 and an adjustment knob 170 adjustably secured to the engagement member 168. The engagement member 168 is formed of a suitable rigid material, such as a plastic or metal, and more particularly of anodized aluminum, and includes a wide lower end 172 and a narrow upper end 174. The wide lower end 172 can include a high friction pad 176 thereon to assist in holding the lower end 172 in a stationary position against the truck bed 11. As shown in FIG. 21, in an exemplary embodiment, as opposed to being formed directly on the engagement member 168, the pad 176 can be formed as a separate member or boot 169 that is removably positioned on the lower end 172 of the engagement member 168. The boot 169 can be formed of a high-friction material, such as a rubber, defining an open upper end 171 adapted to receive the lower end 172 therein, and an exterior 173 having a number of gripping ridges 175 thereon. In one exemplary embodiment the gripping ridges 175 can be formed with hemispherical cross-sections that when engaged with an attaching surface, e.g., a truck bed 11, deflect and act as “mini springs” to provide pressure to hold the component of the divider 110 on which the boot 169 containing the gripping ridges 175 is attached secure to the attaching surface and to protect the attaching surface from becoming damaged. The lower end 172 can be received and retained within the interior 171 using a friction fit between the boot 169 and the lower end 172 and/or any other suitable engaging material, e.g., an adhesive, or structure, e.g., a mechanical fastener.

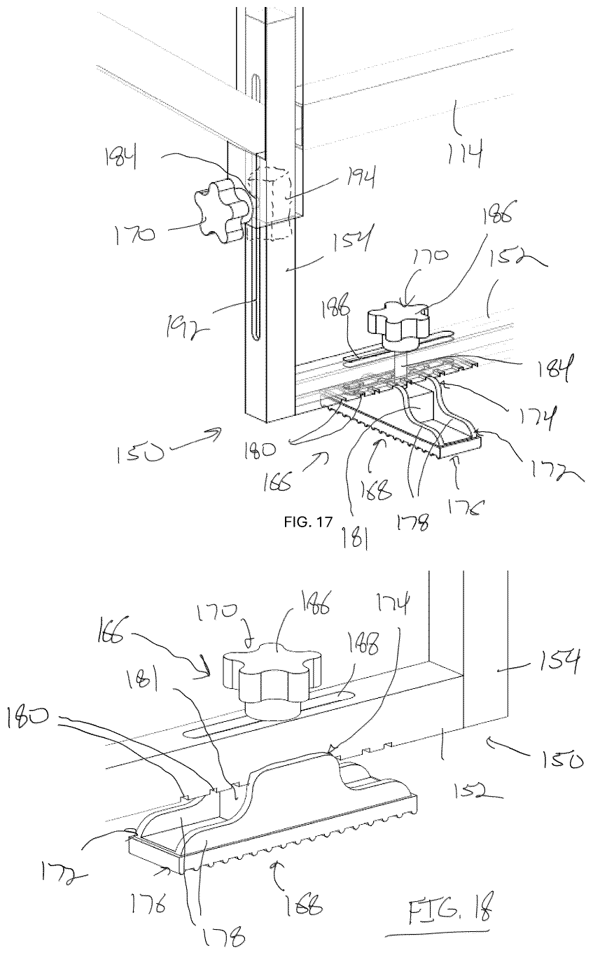

The upper end 174 of the engagement member 168 includes a pair of spaced ridges 178 that can engage complementary shaped notches 180 formed in a lower surface 182 of the lower rail 152, as shown in FIGS. 17, 18 and 20, in order to prevent the upper end 174, and consequently the engagement member 168, from sliding relative to the lower rail 152.

The adjustment knob 170 for each engagement member 168 includes a threaded rod 184 extending outwardly from a handle 186. The rod 184 can be inserted through a slot 188 in the lower rail 152 and into engagement within a threaded bore 190 disposed in the upper end 174 between the ridges 178, such as into a nut 181 disposed between the ridges 178. With the placement of the rod 184 in the slot 188 and engaged with the nut 181, the position of the engagement member 168 can be adjusted relative to the lower rail 152 to ensure the proper placement of the lower end 172 of the engagement member 168 against the truck bed 11 to accommodate for uneven surfaces of the truck bed 11. The engagement of the rod 184 within the bore 190 of the nut 181 also allows the rotation of the knob 170 to pull the ridges 178 of the engagement member 168 into aligned notches 180 on the lower rail 152. This secures the alignment member 168 in position on the lower rail 152, such that when the engagement member 168 is pressed against the truck bed 11 during positioning of the divider 110, the extension 150, and thus the lower rail 114 of the divider 110, are securely engaged to the floor of the truck bed 11 by the engagement members 168. Further, when the divider 110 is not in use within a truck bed 11, as shown in FIG. 18, the spacing of the ridges 178 enables the width of the lower rail 152 to be positioned fully therebetween when the knob 170 is rotated to draw the engagement member 168 against the lower rail 152 into a storage or shipping orientation.

Referring now to the exemplary embodiment of FIGS. 15, 16 and 22-25, the divider 110 includes a first extension arm 140 and a second extension arm 142 engaged within opposed sides 116,118 of the hollow top rail 113 of the frame 112. The first extension arm 140 best shown in FIG. 22 is formed similarly to the arm 40 on divider 10 as shown in FIG. 14 and is inserted within the top rail 113 of the frame 112. To adjustably position and lock the first extension arm 140 relative to the frame 112, the first extension arm 140 includes an adjustment knob 170 having a threaded rod 184 extending through the frame 112, such as through a bore 193 in the frame 112, and into a slot 192 in the first extension arm 140, such that the first extension arm 140 can slide with respect to the stationary rod 184. Opposite the knob 170 the rod 184 is threadedly engaged with a compression member or nut 194 that can be drawn towards the knob 170 by rotating the knob 170 to more fully engage the threaded rod 184 with the compression member 194. In this manner the compression member 194 can engage the first extension arm 140 while the knob 170 engages the frame 112 to compress the first extension arm 140 against the interior of the top rail 113 to hold the first extension arm 140 in frictional engagement with the top rail 113 at the desired location. In addition to the adjustment knob 170, other securing mechanisms can be used in conjunction with or substituted for the adjustment knob 170.

In FIGS. 16 and 23-24, the second extension arm 142 is formed similarly to the first extension arm 140 and is slidably inserted within the frame 112 opposite the first extension arm 140. However, the second extension arm 142 is formed without a slot, such that the second extension arm 142 is formed as a solid member or hollow tube with unbroken walls on each side. Instead, the top surface 196 of the hollow top rail 113 of the frame 112 is formed with an elongate slot 198 having a number of perpendicular key slots 200 intersecting the elongate slot 198 spaced along the length of the elongate slot 198 and an entry slot 201 intersecting the elongate slot 198 opposite the adjacent end of the top rail 113.

To secure the second extension arm 142 at the desired location within the top rail 113, a cam 202 is inserted through the elongate slot 198 and engaged with the second extension arm 142 to compress the second extension arm 142 away from the elongate slot 198 against the interior of the top rail 113. As best shown in FIG. 24, the cam, cam lock or cam lever 202, which is formed of a rigid material, such as a plastic or metal, and more specifically of aluminum, includes a body 204 including a lower narrow portion 206 and a wide upper portion 208. The width of the narrow lower portion 206 is smaller than the width of the elongate slot 198, such that the lower portion 206 can be inserted partially within the elongate slot 198. The wide upper portion 208 has a width larger than the elongate slot 198, such that the upper portion 208 functions as a grasping point or handle for the placement or removal of the cam 202 from the frame 112, in a manner to be described.

The lower portion 206 includes a rounded or arc-shaped projection 210 extending outwardly from the lower portion 206 opposite the upper portion 208 and having width similar to that of the lower portion 206, such that the projection 210 can be inserted at least partially within and/or through the elongate slot 198. The projection 210 also includes a stop member 212 positioned on the projection 210. The stop 212, which can have a rectangular, circular or other suitable cross-sectional shape, extends to either side of the lower portion 206/projection 210 and has a length at least slightly less than the length of the cross-slots 200, such that the stop member 212 can be positioned within and engage a selected one of the cross-slots 200.

In operation, when the second extension arm 142 is positioned at the desired location within the top rail 113, the cam 202 is engaged with the second extension arm 142 to secure the second extension arm 142 to the top rail 113 at that position. To do so, initially, the cam 202 is oriented vertically relative to the top rail 113 to insert the stop member 212 through the entry slot 201. The cam 202 is then moved along the top rail 113 between the second extension arm 142 and the top rail 113 below the elongate slot 198 to align the stop member 212 with a desired one of the key slots 200. When the stop member 212 is located within or aligned with the selected key slot 200, the cam 202 is pivoted to move the projection 210 into and through the elongate slot 198 into contact with the portion of the second extension arm 142 located within the top rail 113, The pivot point for the movement of the cam 202 to direct the projection 210 into the elongate slot 198 is provided by the contact and engagement of the stop member 212 with the aligned cross-slot 200, within which the stop member 212 can rotate as the cam 202 is moved. The shape of the projection 210 is configured to enable the projection 210 to engage and press the second extension arm 142 into frictional clamping engagement with the interior of the top rail 113, and to provide a lock against movement of the cam 202 through the engagement of the stop member 212 with the cross-slot 200. To disengage the cam 202, the wide upper portion 208 can be grasped above the top rail 113 to pivot the cam 202 away from the top rail 113, releasing the clamping force on the second extension arm 142. In other exemplary embodiments, other shapes on the projection 210 of the cam 202 can be employed to prevent the cam 202 from releasing out of the engaged cross-slot 200.

In the exemplary embodiment of FIGS. 16, 23 and 25, a molded rubber boot 214, formed similarly to high friction pad 176, is engageable with the engagement pad 216 of the second extension arm 142 and is used as a spacer to set the exact location of the extension arm 142 and to securely engage the second extension arm 142 with the truck bed 11 without damaging the truck bed 11. A boot 214 can also be employed over the pad 216 of the first extension arm 140. In one exemplary embodiment of the use of the boot 214, the boot 214 is removed from the pad 216 and the cam 202 is engaged in the selected cross-slot 200. The first extension arm 140 is locked into place on the frame 112 and the cam 202 is released, such that the boot 214 can be replaced on the pad 216 for the second extension arm 142 and the cam 202 is re-engaged into the selected cross-slot 200. The thickness of the boot 214 is equal to the travel distance of the rotation of the cam 202 when engaged into the cross-slot 200. The first extension arm 140 is then secured against the truck bed 11, such as by employing the knob 170, threaded rod 184, and an anti-vibration washer 194, discussed previously.

In alternative exemplary embodiments, the extension arms 140,142 can both be formed as first extension arms 140 or second extension arms 142. Further, in still other exemplary embodiments the threaded rods 184 can be engaged directly with the extension arm 140 and/or 142, and the end rails 154 by the threaded portion of the rod 184 directly engaging the perimeter of the slot 192 to draw the extension arm 140 or end rail 154 into engagement with the interior of the frame 112, thereby omitting the compression member 194.

The invention and the manner and process of making and using it are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention.

Various alternative embodiments are contemplated as being within the scope of the following claims particularly pointing out and distinctly claiming the subject matter regarded as the invention.

What is claimed is:

1. A truck bed divider for use with a truck bed including a bottom floor and a pair of opposed side walls extending upwardly from the bottom floor, the divider comprising:
a. a frame having a top rail, a bottom rail, and a pair of opposed side rails joining the top rail and the bottom rail;
b. at least one first adjustable securing member attached to the frame and engageable with the side wall of the truck bed; and
c. an adjustable extension secured to the bottom rail and engageable with the bottom floor of the truck bed.

2. The truck bed divider of claim 1, wherein the adjustable extension comprises:
a. a lower rail; and
b. a pair of end rails extending outwardly from the opposed ends of the lower rail and slidably engaged within the frame.

3. The truck bed divider of claim 2, wherein the pair of end rails are each engaged with the frame by a first adjustable securing member.

4. The truck bed divider of claim 3, wherein the first adjustable securing member comprises:
a. a compression member disposed within the end rail; and
b. a knob including a threaded rod extending outwardly from the knob, the threaded rod engaged with the compression member opposite the knob.

5. The truck bed divider of claim 4, wherein the compression member is disposed within the end rail, and wherein the end rail includes a slot through which the rod is inserted into engagement with the compression member.

6. The truck bed divider of claim 5, wherein the rod is inserted through a bore in the frame aligned with the slot in the end rail.

7. The truck bed divider of claim 2, further comprising a number of feet adjustably engaged with the lower rail, the number of feet engageable with the bottom floor of the truck bed.

8. The truck bed divider of claim 7, wherein the number of feet each comprises:
a. an engagement member including a narrow upper end with a pair of ridges and a wide lower end; and
b. an engagement knob including a threaded rod engaged with the engagement member.

9. The truck bed divider of claim 8, wherein the pair of ridges are selectively alignable with notches formed on the lower rail.

10. The truck bed divider of claim 9, wherein the lower rail includes a slot extending through the lower rail, and where the threaded rod is inserted through the slot into engagement with the engagement member.

11. The truck bed divider of claim 10, wherein the pair of ridges define a space therebetween at least slightly greater than a width of the lower rail.

12. The truck bed divider of claim 8, further including a boot secured to the wide lower end of the engagement member.

13. The truck bed divider of claim 12, wherein the boot defines an interior within which the wide lower end is positioned and a number of gripping ridges opposite the interior.

14. The truck bed divider of claim 1, further comprising an extension arm adjustably disposed within and extending at least partially outwardly from the top rail.

15. The truck bed divider of claim 14, wherein the extension arm is engaged with the top rail by a first adjustable securing member comprising:
a. a compression member disposed within the extension arm; and
b. a knob including a threaded rod extending outwardly from the knob, the threaded rod engaged with the compression member opposite the knob.

16. The truck bed divider of claim 15, wherein the top rail includes a slot extending through the top rail, and where the threaded rod is inserted through the slot into engagement with the compression member.

17. The truck bed divider of claim 14, wherein the extension arm is engaged with the top rail by a second adjustable securing member comprising a cam releasably insertable through the top rail into engagement with the extension arm.

18. The truck bed divider of claim 17, wherein the top rail includes an elongate slot formed therein, and a number of cross-slots intersecting the elongate slot, and wherein the cam comprises:
a. a body including a lower portion and an upper portion;
b. a projection extending outwardly from the lower portion opposite the upper portion, the projection insertable through the elongate slot; and
c. a stop member disposed on the projection and insertable through a cross-slot.

19. The truck bed divider of claim 1, further comprising a pair of extension arms adjustably disposed within and extending at least partially outwardly from opposed ends of the top rail.

20. A method of dividing a truck bed, comprising the steps of:
a. providing the truck bed divider of claim 1; and
b. engaging the truck bed divider within the bed of a truck.
